(19) United States
(12) Patent Application Publication
(10) Pub. No.: US 2017/0157696 A1
(43) Pub. Date: Jun. 8, 2017

(54) Fastening System and Method for Producing a Fastening System

(71) Applicant: Bayerische Motoren Werke Aktiengesellschaft, Muenchen (DE)

(72) Inventors: Ludwig KURZMAIER, Gars am Inn (DE); Paul BRAUN, Wolnzach (DE)

(21) Appl. No.: 15/434,102

(22) Filed: Feb. 16, 2017

Related U.S. Application Data
(63) Continuation of application No. PCT/EP2015/069032, filed on Aug. 19, 2015.

(30) Foreign Application Priority Data
Sep. 25, 2014 (DE) 10 2014 219 372.9

(51) Int. Cl. B23K 11/00; F16B 37/06

(52) U.S. Cl. CPC B23K 11/0053; F16B 37/061; B23K 2201/006

(57) ABSTRACT

A fastening system includes a welding stud that is weldable to a carrier and a disc that is fastened to the welding stud and has an opening. The welding stud has a weld-on portion for welding the welding stud onto the carrier, a flange and a pin-shaped portion having an external thread. The disc has an outside diameter which is greater than a diameter of the flange. The pin-shaped portion has a thread-free region which is arranged between the flange and the external thread, and the disc has a latch configured for pushing the disc over the external thread and by which the disc is latched in place in the thread-free region.

### CROSS REFERENCE TO RELATED APPLICATIONS

This application is a continuation of PCT International Application No. PCT/EP2015/069032, filed Aug. 19, 2015, which claims priority under 35 U.S.C. §119 from German Patent Application No. 10 2014 219 372.9, filed Sep. 25, 2014, the entire disclosures of which are herein expressly incorporated by reference.

### BACKGROUND AND SUMMARY OF THE INVENTION

The invention relates to a fastening system as well as to a method for producing a fastening system. Such a fastening system can be fastened, for example, to a carrier, such as part of a vehicle body.

In the field of fitting techniques it is known how to afix studs onto the surface of workpieces, such as parts of a chassis. This includes so-called stud welding, in which a stud is welded to the surface of a workpiece. Alternative fitting techniques involve, for example, the gluing of a stud onto the surface of a workpiece.

In automotive design, welding studs are used primarily. The welding studs are fastened in a welding process onto a part of a chassis, wherein the welded stud is welded by its head to the chassis part, and components are then fastened onto the shaft of the welding stud by use of nuts or clamps. The flange of the welding stud here forms the abutment on which the components arranged on the shaft are braced. Therefore, the size of the flange governs the maximum size of the opening in the component that surrounds the shaft, since too large an opening in relation to the size of the flange no longer assures an adequate bracing of the component on the flange. Furthermore, the size of the opening surrounding the shaft in the component being attached also determines the largest possible position deviation which the component can have relative to the welding stud. If large position deviations are to be permitted, this requires a correspondingly large opening and a large flange. DE 10 2005 017 379 A1 discloses a fastening element in which a washer is provided to enlarge the bearing surface, being undetachably connected between the head and the external thread of the shaft of a welding stud. In the fabrication of such a fastening element, a welding stud with a head and a smooth shaft is formed from a section of wire by cold forming. The washer is then placed on the smooth shaft of the welded bolt and after this an external thread is rolled onto the shaft of the welding stud.

Stud welding processes are often done in an automated manner, especially in the motor vehicle industry, where many welding studs are fitted to a vehicle panel in order to create anchors for fastening means, linings, etc. The automated fitting of studs to workpieces is done, e.g., by one or more robots, each of which has a fitting head. The fitting head of the robot is, in this case, connected to a supply unit, providing for example the electric welding current and other control signals. Furthermore, it is preferable to feed the studs to the fitting head in automated manner. This is generally done by compressed air through feed hoses. The diameter of the feed hoses here is generally only slightly larger than the diameter of the flange sections of the studs, in order to make possible an easy transport of the studs. Especially when using a plurality of welding robots at a workpiece, the studs can only be set down with an accuracy of around 2.5 mm and often required accuracies of under 1.5 mm are not achieved.

Known fastening elements thus have the drawback that they either have relatively small bearing surfaces that are not suitable for equalizing tolerances or else, in the case of welding studs with undetachably connected washers for example, can no longer be used in fully automated processes employing welding robots on account of the size of the washers. This is especially due to the fact that the feeding hoses to the fitting head of the robot are often not suited to transporting such welding studs with washers attached thereon, on account of their diameter.

One problem to be solved in at least some of the embodiments is to provide a fastening system which, on the one hand, has a large-area abutment for the components being attached and, on the other hand, is suited to being used in an automated welding process by way of a robot. Another problem to be solved in at least some of the embodiments is to provide a method for producing a fastening system.

These problems are solved by a system and a method according to embodiments of the invention.

A fastening system according to at least one embodiment includes a welding stud that is weldable to a carrier. The carrier can be, for example, a vehicle body or part of a vehicle body. The welding stud preferably comprises a weld-on portion for welding the welding stud onto the carrier, a flange, and a pin-shaped portion, which comprises an external thread. For example, the welding stud can be a so-called large flange stud, which can be used in a fully automated welding process. The welding stud preferably has at least a strength of strength class 6.8. Especially preferably, the welding stud has a strength of strength class 8.8. The welding stud can have a length of, e.g. 22 mm in the axial direction and the pin-shaped portion a length of 13 mm.

The fastening system furthermore includes a disk fastened on the welding stud, having an opening. Preferably, the disk is fastened on the welding stud such that it is placed by its opening onto the welding stud and the pin-shaped portion of the welding stud sticks through the opening. It is furthermore preferable for the disk to have an outer diameter which is larger than a diameter of the flange of the welding stud. In this way, a bearing surface of the welding stud can be advantageously enlarged. The pin-shaped portion has a thread-free region arranged between the flange and the external thread. The thread-free region thus extends from the end of the flange to the beginning of the external thread of the welding stud. The disk includes a latch which is configured for pushing the disk over the external thread and by which the disk is latched in place in the thread-free region.

Advantageously, unwanted tolerances, such as occur for example on account of the use of a plurality of robots on a carrier, can be equalized by use of the disk latched in place in the thread-free region of the welding stud. The disk, after the latching in place in the thread-free region of the pin-shaped portion is preferably at least held firmly enough so that it cannot be pulled off from the pin-shaped portion by forces acting on the disk and corresponding in order of magnitude to roughly the gravity force of the disk. In this way, it can be prevented, e.g., that the disk can drop off from the welding stud during a rotation of the carrier, such as can occur for example in swivel mounting or cathodic hot-dip painting.

According to another embodiment, the latch is deformable. For example, the latch can be elastically deformable. This means that the latch after a deformation, can again return to its original state. Furthermore, it is also possible for the latch to be at least in part plastically deformable. This means that the latch, after a deformation, can remain at least partly in its deformed state.

For example, the opening of the disk has a diameter between 5.0 mm and 7.0 mm, preferably 6.0 mm. The external thread according to a preferred embodiment has a larger diameter than the opening of the disk. In particular, the largest dimension of the external thread in the radial direction, i.e., in a direction perpendicular to the axial direction of the pin-shaped portion, can be larger than the diameter of the opening of the disk.

According to another embodiment, the disk has an inner region and an outer region. The inner region preferably borders directly on the opening of the disk. The outer region preferably borders directly on the inner region surrounding the opening. Preferably, the inner region and the outer region of the disk have a different material from each other. For example, the outer region can comprise a metal and the inner region an elastic material. According to one preferred embodiment, the inner region comprises a plastic material and the outer region comprises a metal, such as steel. The inner region of the disk here forms the latch of the disk, by means of which the disk can be latched in place in the thread-free region. In particular, the disk can be pushed over the external thread of the welding stud by means of the inner region comprising the plastic material and then be held firmly in the thread-free region. According to an especially preferred embodiment, the inner region consists of a plastic material and the outer region consists of a metal. The inner region can also comprise rubber or consist of it.

According to another embodiment, the disk consists of a plastic material. Preferably, the plastic material is heat-resistant up to 200° C. for a period of at least 30 minutes. Furthermore, the disk can consist of rubber.

According to another embodiment, the disk has projecting clamping portions in the direction of the opening. The clamping portions in this case form the latch of the disk. Preferably the disk has at least two projecting clamping portions, which protrude in the radial direction toward the opening. Furthermore, the disk can have precisely two projecting clamping portions. Preferably, the disk has three projecting clamping portions. Especially preferably, the disk has four projecting clamping portions. Furthermore, it is possible for the disk to have more than four projecting clamping portions. By means of the clamping portions, the disk can be pushed over the external thread and latched in place in the thread-free region of the pin-shaped portion.

Preferably, the disk has no threaded portion, also especially not in the area of the opening of the disk. Thus, the disk is preferably not a screw nut with an internal thread.

According to another embodiment, the weld-on portion, the flange, and the pin-shaped portion of the welding stud are formed as a single piece. Preferably the welding stud is completely finished, that is, the weld-on portion, the flange, and the pin-shaped portion having the external thread and the thread-free region are fully formed when the disk is joined to the welding stud. For example, the welding stud can include steel or be made of steel and be galvanized.

According to another embodiment, the length of the thread-free region is greater than or equal to the thickness of the disk. That is, the thread-free region in the axial direction, i.e., the distance from the end of the flange to the beginning of the external thread in the axial direction, is preferably greater than or equal to the thickness of the disk. For example, the disk, especially if the thread-free region in the axial direction is longer than the thickness of the disk, may be floating between the flange and the external thread. In other words, the disk then is latched in place between the flange and the external thread such that it is arranged movably in the thread-free region between the flange and the external thread. Furthermore, however, it is also possible for the disk to be arranged firmly in the thread-free region between the flange and the external thread, for example, if the length of the thread-free region in the axial direction is equal to the thickness of the disk. The thickness of the disk is, e.g., between 0.5 mm and 1.5 mm, according to a preferred embodiment 1.0 mm.

According to another embodiment, the ratio of the outer diameter of the disk to the diameter of the flange is at least 1.5. According to another preferred embodiment, the ratio of the outer diameter of the disk to the diameter of the flange is at least 1.7. In this way, a sufficiently large bearing surface of the fastening system can be advantageously achieved for components being fastened to it. Preferably the size of the outer diameter of the disk is adapted to a bearing surface of an attaching part being fastened to the carrier. For example, the disk has an outer diameter between 20 mm and 25 mm.

Moreover, a method is provided for producing a fastening system. The fastening system produced, or which can be produced, in this way can have one or more features of the aforementioned embodiments. The embodiments described above and in the following apply equally to the fastening system and to the method for producing the fastening system.

According to one embodiment, for the producing of the fastening system in a first method step, one makes ready a carrier, a welding stud which has a flange and a pin-shaped portion having an external thread, and a disk having an opening. The carrier can be in particular a part of a vehicle body. The welding stud can be configured as described above, for example. Next, the welding stud is fastened to the carrier by a welding process. Preferably, the fastening of the welding stud to the carrier is done by means of a fully automated fastening process, for example one making use of a welding robot having a fitting head with a feed hose. After the fastening of the welding stud to the carrier, the disk is placed on the welding stud such that the disk is latched in place on the pin-shaped portion and held in place on the pin-shaped portion.

According to a preferred embodiment, the disk while being placed on the welding stud is pushed over the external thread of the pin-shaped portion. Therefore, the disk is preferably configured such that it can be moved by its opening over the external thread of the pin-shaped portion of the welding stud.

According to another embodiment, the pin-shaped portion has a thread-free region which is arranged between the flange and the external thread. The disk preferably includes a latch which is designed for the pushing of the disk over the external thread and for latching the disk in place in the thread-free region. In particular, the disk can comprise latches as were described above in connection with the fastening system.

According to another embodiment, the step of fastening the welding stud to the carrier is carried out in an automated manner, in particular, fully automated. For example, at least one welding robot can be used here with a fitting head and a connected supply unit and a feed hose, which feeds the welding stud in automated fashion.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic sectional view of a welding stud according to one exemplary embodiment.

FIG. 2A and 2B illustrate a disk in a perspective representation and in a side view according to one exemplary embodiment.

FIG. 3A to 3C illustrate disks with latches according to three different exemplary embodiments.

FIG. 4 illustrates a fastening system attached to a carrier according to one exemplary embodiment.

FIG. 5 is a schematic representation of a method for the making of a fastening system according to another exemplary embodiment.

### DETAILED DESCRIPTION OF THE DRAWINGS

In the exemplary embodiments and figures, the same or equivalent acting components can be provided with the same reference numbers. The elements represented and their size relations among each other should basically not be considered true to scale. Instead, individual elements, such as layers, components and areas, can be shown exaggerated in thickness or size for better visibility and/or better comprehension.

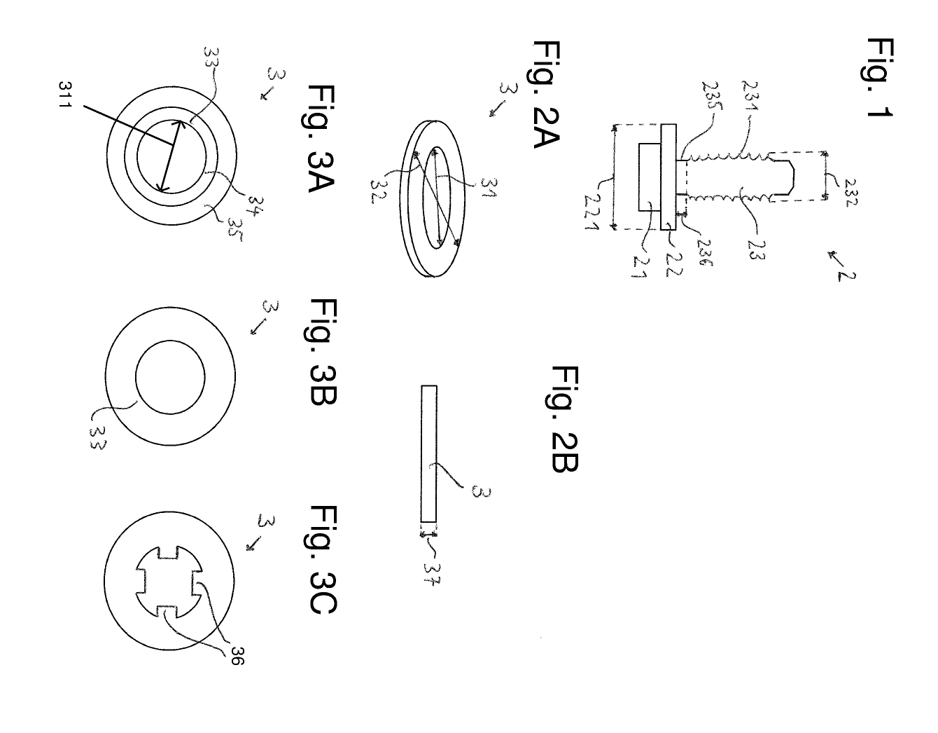

FIG. 1 shows a schematic sectional view of a welding stud 2 which can be welded onto a carrier. The welding stud 2 has a weld-on portion 21 for welding the welding stud 2 onto a carrier, a flange 22, and a pin-shaped portion 23 having an external thread 231. Between the flange 22 and the external thread 231 is arranged a thread-free region 235. The flange 22 has a diameter 221. The thread-free region 235 has a length 236 in the axial direction which corresponds to the distance between the flange 22 and the external thread 231 in the axial direction. The external thread 231 has a diameter 232 which represents the largest diameter of the pin-shaped portion 23 in the radial direction, i.e., in a direction perpendicular to the axial direction.

FIG. 2A shows a disk 3 with an opening 31 in a perspective view. FIG. 2B shows the disk of FIG. 2A in a side view. The disk 3 has a thickness 37. The opening 31 of the disk 3 has a diameter 311 which can also be called the inner diameter of the disk 3, and an outer diameter 32.

FIGS. 3A to 3C show various exemplary embodiments of a disk 3 in top view. The disk 3 has a latch 33, which is suitable for pushing the disk 3 over the external thread 231 and by which the disk 3 can be latched in place in the thread-free region 235 of the welding stud 2.

In the embodiment of FIG. 3A, the disk has an inner region 34, comprising a plastic material. The inner region 34 borders directly on the opening 31 of the disk 3. The opening 31 of the disk 3 has a diameter 311 of 6.0 mm. Alternatively, the disk 3 can have a diameter between 5.0 mm and 7.0 mm. Moreover, the disk 3 has an outer region 35, which comprises a metal. The outer region 35 borders directly on the inner region 34. By way of the inner region 33 comprising the plastic material, the disk 3 has a latch 33 by which the disk can be pushed over the external thread 231 of the welding stud 2. After being pushed over the external thread 231, the disk is latched in place in the thread-free region 235 of the welding stud 2.

According to the embodiment of FIG. 3B, the disk 3 consists of plastic. Thus, the disk 3 is deformable, in particular, elastically deformable. The region bordering on the opening, which is made of plastic, functions as latch 33 as described above.

The disk 3 according to the embodiment of FIG. 3C comprises projecting clamping portions 36, which protrude in the direction of the opening 31 into the opening 31. By means of the projecting clamping portions 36, the disk 3 can be latched in place in the thread-free region 235 of the welding stud 2. Thus, the projecting clamping portions 36 form the latch 33 of the disk.

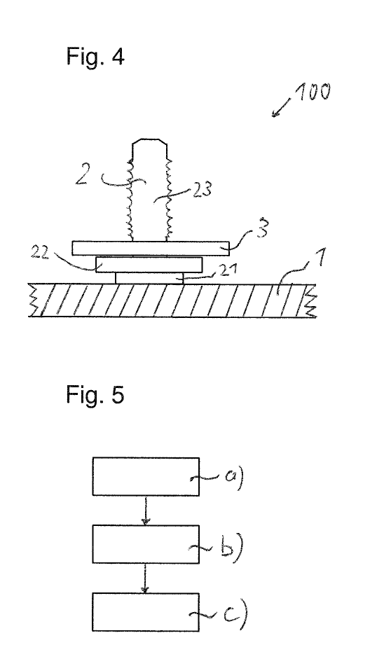

FIG. 4 shows a fastening system 100 having a welding stud 2 and a disk 3 connected to the welding stud 2, and connected to a carrier 1, which can be part of a vehicle body, for example. FIG. 4 only shows a cutout of the carrier 1. Preferably, the disk 3 has a larger outer diameter 32 than the diameter 221 of the flange 22. In this way, a large-area abutment can be provided for components being attached to the fastening systems.

The fastening system 100 described here is also characterized, in particular, by the fact that it is easy and cheap to produce.

FIG. 5 shows a schematic representation of a method for producing a fastening system 100. The method includes at least the steps a) to c), explained below. In step a), a carrier 1, a welding stud 2, as well as a disk 3 with an opening 31 are made ready. The welding stud 2 has a flange 22 and a pin-shaped portion 23 having an external thread 231. In method step b), the welding stud 2 is connected to the carrier 1 by a welding process. Preferably, the welding stud 2 has a weld-on portion 21, by means of which the welding stud 2 is welded to the carrier 1, so that the welding stud 2 is secured to the carrier 1 and sticks out from it. The welding stud 2 is suitable for the attachment of components to the carrier 1. In a method step c), following method step b), the disk 3 is placed on the welding stud 2 in such a way that the disk 3 is latched in place on the pin-shaped portion 23 and held in place on the pin-shaped portion 23. For example, the disk 3 is pushed here by its opening over the external thread 231. For example, the disk 3 can be put in place in the body fabrication or the assembly process, as needed.

Preferably, the pin-shaped portion 23 has a thread-free region 235, arranged between the flange 22 and the external thread 231, and the disk 3 has a latch 33 which is designed for pushing the disk 3 over the external thread 231 and serve to latch the disk 3 in place in the thread-free region 235. In this way, on the one hand, it can be assured that the disk 3 after the fastening of the welding stud 2 already provided with the external thread 231 on the carrier 1 can be moved by its opening 31 over the external thread 231 as far as the thread-free region 235, and on the other hand a latching of the disk 3 in place in the thread-free region 235 is created, so that the disk 3 cannot fall off from the pin-shaped portion 23 of the welding stud 2 during a rotation of the carrier 1.

The step of fastening the welding stud 2 to the carrier 1 is preferably automated, in particular, fully automated, wherein a welding robot can be used, for example. The placement of the disk 3 on the welding stud 2 can be done manually. However, it is also contemplated that this step is also done in an automated manner, for example, by another robot.

### LIST OF REFERENCE SYMBOLS

1 carrier

100 fastening system

2 welding stud

21 weld-on portion

22 flange

221 diameter of flange

23 pin-shaped portion

231 external thread

232 diameter of external thread

235 thread-free region

236 length of thread-free region

3 disk

31 opening

311 diameter of opening

32 outer diameter

33 latch

34 inner region

35 outer region

36 clamping portion

37 thickness of the disk

a) b) c) method step

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fastening system, comprising:
a welding stud that is weldable to a carrier; and
a disk fastened on the welding stud, the disk having an opening, wherein
the welding stud comprises a weld-on portion for welding the welding stud onto the carrier, a flange, and a pin-shaped portion having an external thread,
the disk has an outer diameter which is larger than a diameter of the flange,
the pin-shaped portion has a thread-free region arranged between the flange and the external thread, and
the disk comprises a latch configured for pushing the disk over the external thread and by which the disk is latched in place in the thread-free region.

2. The fastening system as claimed in claim 1, wherein the latch is elastically or plastically deformable.

3. The fastening system as claimed in claim 2, wherein the external thread has a larger diameter than the opening of the disk.

4. The fastening system as claimed in claim 1, wherein
the disk has an inner region and an outer region, and
the inner region comprises a plastic material and the outer region comprises a metal.

5. The fastening system as claimed in claim 1, wherein the disk is made of a plastic material.

6. The fastening system as claimed in claim 1, wherein the disk comprises projecting clamping portions in the direction of the opening.

7. The fastening system as claimed in claim 1, wherein the weld-on portion, the flange, and the pin-shaped portion are formed as a single piece.

8. The fastening system as claimed in claim 1, wherein a length of the thread-free region is greater than or equal to a thickness of the disk.

9. The fastening system as claimed in claim 1, wherein a ratio of the outer diameter of the disk to the diameter of the flange is at least 1.5.

10. A method for producing a fastening system, the method comprising the acts of:
a) providing a carrier, a welding stud which has a flange and a pin-shaped portion having an external thread, and a disk having an opening;
b) fastening the welding stud to the carrier by a welding process;
c) subsequently placing the disk on the welding stud such that the disk is latched in place on the pin-shaped portion and held in place on the pin-shaped portion.

11. The method as claimed in claim 10, wherein the disk in method act c) is pushed over the external thread.

12. The method as claimed in claim 11, wherein
the pin-shaped portion has a thread-free region which is arranged between the flange and the external thread, and
the disk comprises a latch designed for pushing of the disk over the external thread and for latching the disk in place in the thread-free region.

13. The fastening system as claimed in claim 12, wherein the act of fastening the welding stud to the carrier is carried out in an automated manner.
